(19) United States
(12) Patent Application Publication
(10) Pub. No.: US 2010/0332286 A1
(43) Pub. Date: Dec. 30, 2010

(54) PREDICTING COMMUNICATION OUTCOME BASED ON A REGRESSION MODEL

(75) Inventors: I. Dan MELAMED, New York, NY (US); Yeon-Jun KIM, Whippany, NJ (US); Andrej LJOLJE, Morris Plains, NJ (US); Bernard S. RENGER, New Providence, NJ (US); David J. SMITH, Millington, NJ (US)

Correspondence Address: AT & T LEGAL DEPARTMENT - GB;ATTN: PATENT DOCKETING, ROOM 2A- 207, ONE AT & T WAY, BEDMINSTER, NJ, 07921, US

(73) Assignee: AT&T INTELLECTUAL PROPERTY I, L.P.,, Reno, NV (US)

(21) Appl. No.: 12/490,662

(22) Filed: Jun. 24, 2009

(51) Int. Cl. G06Q 10/00; G06N 7/02

(52) U.S. Cl. 705/10; 706/52; 705/11; 705/7

(57) ABSTRACT

Predicting a score related to a communication sent by a sender over a communications network to a first agent servicing the communication includes obtaining a regression result for an objective function by encoding features extracted from the communication. The encoded features are applied to a regression model for the objective function. The regression result is output to a network component in the communications network. The regression model is determined prior to or concurrently with receiving the communication from the sender.

### BACKGROUND

1. Field of the Disclosure

The present disclosure relates to the field of communication processing. More particularly, the present disclosure relates to systems and methods for predicting communication outcome based on a regression model.

2. Background Information

In a typical call center, telephone calls are received from customers that desire to speak with a customer service agent or operator to resolve an issue, purchase a product or service, or obtain information relating to products and services. While some telephone calls result in a desired resolution to a customer's inquiry, customers may experience difficulty or frustration in conveying their needs to the customer service agent in other situations. In such situations, the customer may attempt to re-characterize his or her inquiry and the customer service agent may attempt to re-interpret the customer's communication.

The quality of the customer's interaction with the customer service agent affects the type of feedback the customer may leave with regard to the customer service agent's performance. Feedback is used to monitor the performance of customer service agents and to update and improve standard business practices.

### BRIEF DESCRIPTION OF THE DRAWINGS

FIG. 1 shows an exemplary general computer system that includes a set of instructions for predicting communication outcome based on a regression model;

FIG. 2 shows a system diagram for obtaining and storing training data, according to an aspect of the present disclosure;

FIG. 3 shows a process flow diagram for determining a regression model, according to an aspect of the present disclosure;

FIG. 4A shows a process flow diagram for predicting a score based on the regression model, according to an aspect of the present disclosure;

FIG. 4B shows a process flow diagram for implementing a first prescribed course of action, according to an aspect of the present disclosure;

FIG. 5 shows a process flow diagram for implementing a second prescribed course of action, according to an aspect of the present disclosure;

FIG. 6 shows a process flow diagram for implementing a third prescribed course of action, according to an aspect of the present disclosure; and

FIG. 7 shows a process flow diagram for implementing a fourth prescribed course of action, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

According to one aspect of the present disclosure, a method for predicting a score related to a communication sent by a sender over a communications network to a first agent servicing the communication includes obtaining a regression result for an objective function by encoding features extracted from the communication. The method includes applying the encoded features to a regression model for the objective function. The method includes outputting the regression result to a network component in the communications network. The regression model is determined prior to or concurrently with receiving the communication from the sender.

According to another aspect of the present disclosure, the regression model for the objective function is determined based on communication transcripts and performance data.

According to yet another aspect of the present disclosure, the features include communication metadata, acoustic, lexical, syntactic, prosodic, semantic and phonetic features of the communication.

According to still another aspect of the present disclosure, the regression result is obtained in real-time as the communication is being sent by the sender.

According to one aspect of the present disclosure, the method includes evaluating performance for the first agent servicing the communication, based on the regression result, by reviewing a stored version of the communication.

According to another aspect of the present disclosure, predetermined methods for training the first agent are revised based on at least one of the regression result and evaluating performance for the first agent servicing the communication.

According to yet another aspect of the present disclosure, an alert is generated when the regression result is less than a predetermined threshold.

According to still aspect of the present disclosure, the method includes escalating the communication to a second agent in real-time when the regression result is less than a predetermined threshold.

According to one aspect of the present disclosure, the communication is routed to a second agent based on at least one of: features of the communication, the regression result, a plurality of agent profiles, a profile for the sender and a history of communications initiated by the sender and a plurality of agent profiles.

According to another aspect of the present disclosure, the performance data comprises numeric, encoded and binary answers to a plurality of survey questions.

According to one aspect of the present disclosure, a system for predicting a score related to a communication sent by a sender over a communications network to a first agent servicing the communication includes an obtainer, implemented on at least one processor, that obtains a regression result for an objective function by encoding features extracted from the communication and applying the encoded features to a regression model for the objective function. The system includes an outputter, implemented on at least one processor, that outputs the regression result to a network component in the communications network. The regression model is determined prior to or concurrently with receiving the communication from the sender.

According to another aspect of the present disclosure, the communication includes text messages, short messaging system messages, electronic mail, facsimile, postal mail, Internet web posts, chat client messaging, audio files and video files.

According to yet another aspect of the present disclosure, the objective function represents a survey question and the regression result predicts a survey answer to the survey question.

According to still another aspect of the present disclosure, the first agent is a human agent or a computer-based agent.

According to one aspect of the present disclosure, the first agent is an interactive voice response system.

According to another aspect of the present disclosure, the system includes a database storing recommendations for products and services.

According to still another aspect of the present disclosure, the recommendations for products and services are based on at least one of the regression result and correlating features extracted from pre-stored call transcripts with products and services offered to or purchased by senders of the pre-stored call transcripts.

According to yet another aspect of the present disclosure, the recommendations for products and services are automatically provided to the sender.

According to one aspect of the present disclosure, the first agent provides the recommendations to the sender.

According to one aspect of the present disclosure, a computer readable medium, storing a computer program recorded on the computer readable medium, predicts a score related to a communication sent by a sender over a communications network to a first agent servicing the communication. The computer readable medium includes an obtaining code segment, recorded on the computer readable medium, that obtains a regression result for an objective function by encoding features extracted from the communication and applies the encoded features to a regression model for the objective function. The computer readable medium includes an outputting code segment, recorded on the computer readable medium, that outputs the regression result to a network component in the communications network. The regression model is determined prior to or concurrently with receiving the communication from the sender.

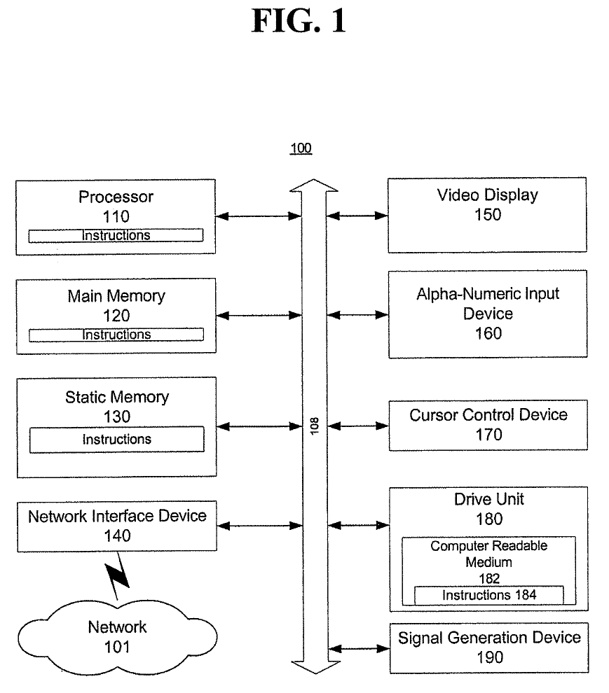

FIG. 1 is an illustrative embodiment of a general computer system, on which a method to provide dynamic speech processing services during variable network connectivity can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 126, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

FIG. 1 is an illustrative embodiment of a general computer system, on which a method of detecting pre-determined phrases to determine compliance quality can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g., software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

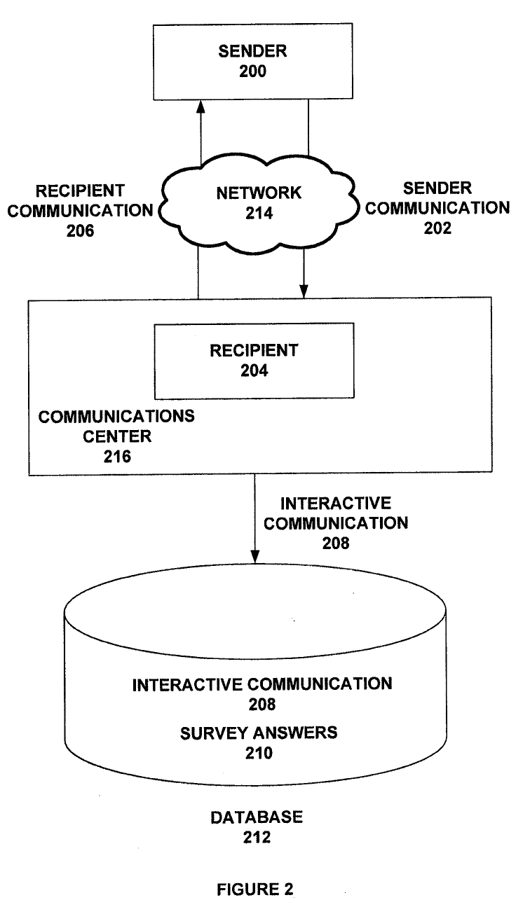

In FIG. 2, a system diagram for obtaining and storing training data is shown. Initially, interaction between a sender 200 and a recipient 204 is captured as interactive communication 208 and stored in a database 212. The interactive communication 208 is a collection of sender communication 202 sent by the sender 200 to the recipient 204 and recipient communication 206 sent by the recipient 204 to the sender 200. Communication is any of, but not limited to a: textual, audio or video representation of interaction between the sender 200 and the recipient 204. A textual representation of the interactive communication 208 is any of, but not limited to: text messages, short messaging system messages, electronic mail, facsimile, postal mail, Internet web posts and chat client messaging. An audio representation of the interactive communication 208 is an analog or digital file representation of in-person oral conversations, distant conversations and/or telephone calls between the sender 200 and the recipient 204. A video representation is an analog or digital file representation of in-person conversations, video conferences and/or distant conversations between the sender 200 and the recipient 204. In one non-limiting embodiment, interactions between the sender 200 and the recipient 204 occur in real-time or near real-time.

Interactions between the sender 200 and the recipient 204 occur via any of the following, but not limited to: in-person communications and network 214. Network 214 includes any one or combination of the following: telecommunications networks, data networks, satellite networks, wireless networks, wireline networks, the Internet, intranets, local area networks, wide area networks, virtual private networks, packet-switching networks and circuit-switching networks. As will be understood by one of ordinary skill in the art, the network 214 is any network or combination of networks that facilitates the transfer of data allowing for interaction between the sender 200 and the recipient 204.

In one embodiment, the recipient 204 is a service agent located at a communications center 216. The service agent is a human agent or is an automated service agent. For example, in one embodiment, the service agent is an interactive voice response system. It should be understood by one of ordinary skill in the art that the recipient 204 is one or more service agents. In another embodiment, the sender 200 is a subscriber to a product or a service, or a potential subscriber to products and/or services.

At the conclusion of the interaction between the sender 200 and the recipient 204, the interactive communication 208 is stored in the database 212. In addition, the sender 200 completes a survey. The survey or a portion of the survey indicates an evaluation by the sender 200 with regard to interaction with the recipient 204. For example, the survey may indicate a level of satisfaction with regard to the interaction. The survey may indicate, in addition or in the alternative, whether the sender 200 purchased a product based on interaction with the recipient 204. Survey questions are answerable using a numerical score or a binary answer. Alternatively, survey questions are answerable using qualitative answers that are subsequently encoded. Examples of survey questions answerable using qualitative answers include, “How satisfied are you with your interaction with the service agent” and “What would you like improved about your interaction with the service agent.” Answers to these survey questions are encoded according to a degree or level of granularity determined by a designer of the survey or survey question. For example, qualitative answers may be encoded on a scale of 1-10, with 1 indicating an extremely dissatisfied sender and 10 indicating an extremely satisfied sender. Alternatively, qualitative answers may be encoded on a scale of 0-1.0, with 0 indicating a fairly satisfied sender and 1.0 indicating a fairly dissatisfied sender. As will be understood by one of ordinary skill in the art, the level of granularity at which qualitative answers are encoded and the encoded value assigned to each qualitative answer are customizable variables. The terms encoded values (for qualitative features) and encoded features are used interchangeably herein. It should be noted that the sender does not answer survey questions during each instance of communicating with the communications center. Moreover, the sender may not even answer survey questions in a majority instances of communicating with the communications center. Survey questions may not be presented during each of the sender's interactions with the communications center. Even if survey questions are presented to the sender, the sender may choose not to answer the survey questions for a number reasons.

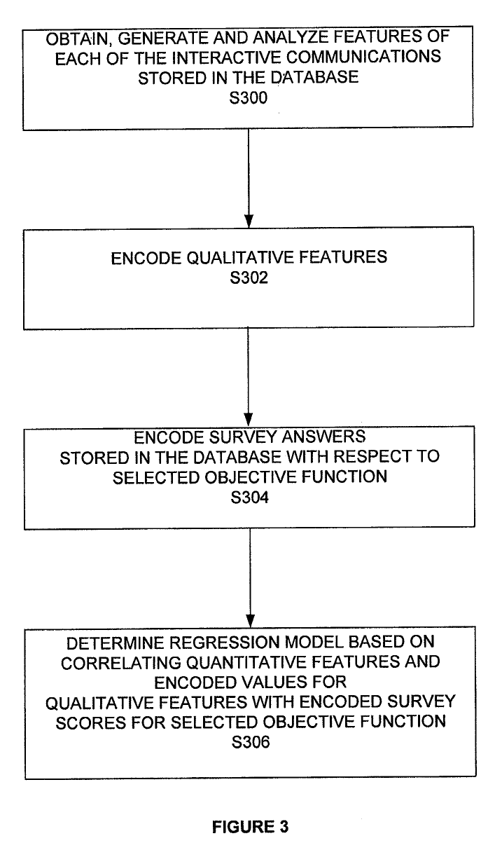

The survey includes any question or questions a designer of the survey wants to answer with respect to the interaction between the sender 200 and the recipient 204. The sender 200 answers the question or questions included in the survey, and survey answers 210 are stored in a database 212. The survey answers 210 provided by the sender 200 are stored with the interactive communication 208 (to which the survey answers 210 correspond) between the sender 200 and the recipient 204. The interactive communication 208 is collected for a number of interactions between various senders and various recipients. The interactive communication 208 is collected over a period of minutes., hours, days, weeks, months or years. The time period over which the interactive communication is collected is determined by a system architect and/or based on operating procedures, business decisions, and goals for the communications center 216. The accumulated interactive communication 208 and the survey answers 210 stored in the database 212 are collectively termed “training data”. The training data is provided as input to determine a regression model, as described with respect to FIG. 3, that defines one or more relationships between the interactive communication 208 and the survey answers 210.

In FIG. 3, a process flow diagram for determining a regression model is shown. In step S300, for each distinct interactive communication, which is interchangeably termed training data, stored in the database, features are obtained and/or generated, and analyzed. Features of the interactive communication include any of the following, but are not limited to: interactive communication metadata, acoustic (e.g., pitch variance), prosodic, phonetic, lexical, syntactic and semantic features. For example, features include the number of words per sentence in the interactive communication, the number of times a “negative” word is uttered, the frequency at which the sender interrupts the recipient and vice versa, the number of times a curse word is uttered and the frequency or speed at which a voice pitch indicating emotional stress is attained. Features of the interactive communication also include the emotional state of the sender; whether the interactive communication is a statement, a question or a command; whether the sender is characterized as communicating ironically, angrily or sarcastically; as well as the emphasis, contrast and focus of the interactive communication. Features also include word selection or connotation. As will be understood by one of ordinary skill in the art, features of the interactive communication include any observable quantity or quality of the interactive communication.

Interactive communication metadata includes any of the following, but is not limited to: a communication mode, communication duration, a size and/or length of the interactive communication, a communication address for a sender, a communication address for a recipient, a date and time at which the interactive communication is initiated, a date and time at which the interactive communication is terminated, a geographic location from which the interactive communication is initiated and a geographic location at which the interactive communication is terminated.

In step S302, qualitative features obtained and analyzed with respect to the interactive communication are encoded. For example, a qualitative feature indicating the tone of the interactive communication (e.g., sarcastic, inquisitive, ironic and puzzled) is encoded as a number between 1 and 4 (e.g., sarcastic=1, inquisitive=2, ironic=3 and puzzled=4). It is noted that any numeric value is used to describe the qualitative feature. As another example, whether the interactive communication is a statement, a question, or a command is encoded as a number between 1 and 3 (e.g., question=1, statement=2 and command=3). In one embodiment, the scale or the encoded values applied to the qualitative features increases based on a degree for the qualitative feature. In another embodiment, the scale or the encoded values applied to the qualitative features decreases based on a degree for the qualitative feature. In one embodiment, with regard to whether the interactive communication is a statement, a question, or a command, the quantitative value (i.e., 1, 2 or 3) increases based on the degree of assertiveness of a communicator, that is, either a sender or a recipient. It is not necessary to encode quantitative features such as communication duration and the number of words in each sentence. However, as will be understood by one of ordinary skill in the art, quantitative features may be normalized and otherwise transformed to facilitate comparison.

In step S304, survey answers stored in the database are encoded. Survey answers are encoded in a manner similar to that noted with respect to encoding qualitative features. In step S306, a regression equation or model is determined by correlating quantitative features and encoded values for quantitative features (i.e., values for independent variables) with encoded survey answers (i.e., values for the dependent variable). It should be noted that any number of quantitative features and encoded values for qualitative features are correlated with a set of survey answers (i.e., survey answers for a single survey question). As will be explained in further detail below, the regression model predicts a future survey answer or score for an objective function (i.e., a survey question), based on currently observed features or characteristics of the interactive communication between the sender and the recipient. It is noted that any combination of features identified in step S300 are used as values for independent variables that are correlated with the dependent variable, a selected survey answer of the numerous survey answers stored for each interactive communication stored in the database. In one embodiment, the regression model is an L1-regularized regression.

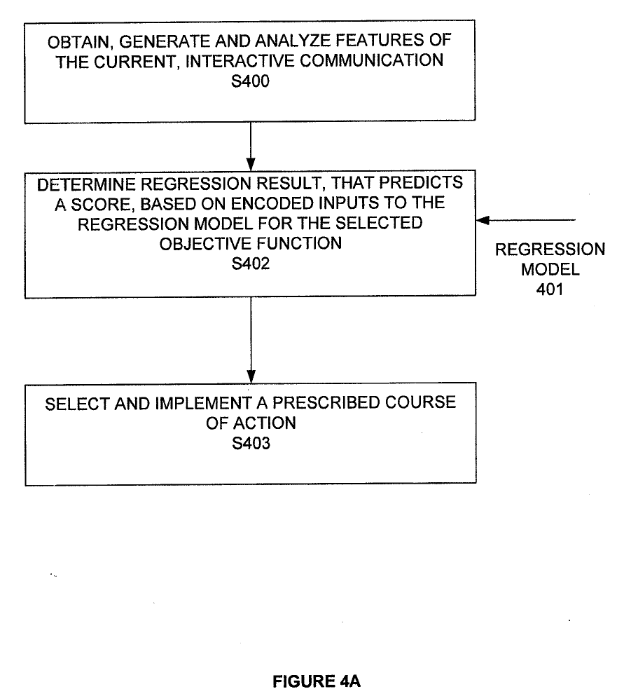

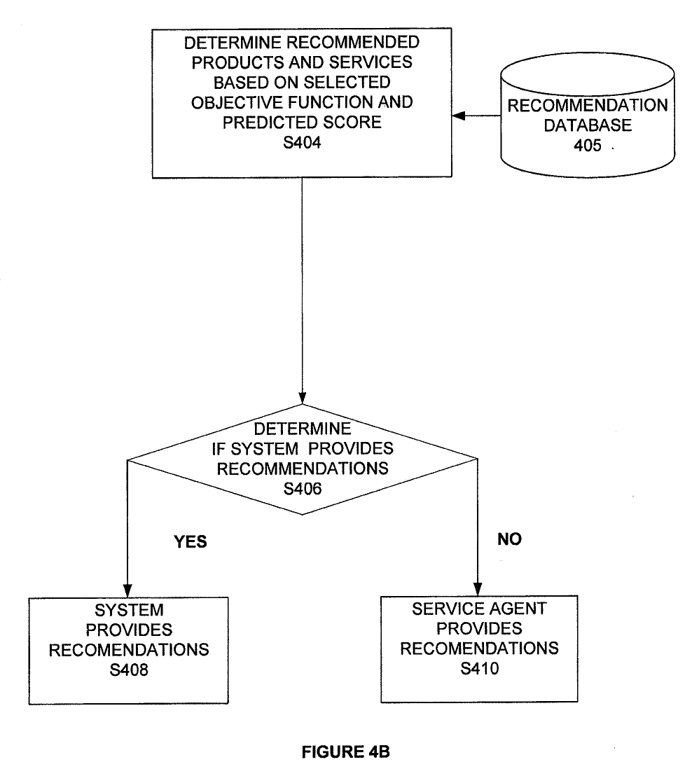

In FIG. 4A, a process flow diagram for predicting a score or survey answer to a selected objective function is shown. In step S400, an interactive communication is analyzed to generate features in a manner similar to the process described with respect to FIG. 3. It should noted that the terms interactive communication and current communication are used interchangeably herein. Qualitative features are also encoded, in step S400. In step S402, a regression result is determined for the selected objective function for which a regression model 401 has been determined. The regression result predicts a score for a question, determination or evaluation represented by the selected objective function. The terms potential survey score, predicted score, predicted survey score, and potential score are used interchangeably herein. In one embodiment, the predicted score for the selected objective function is provided with a confidence interval to indicate a degree of closeness between the regression model and the training data used to generate the regression model. The objective function is representative of any question, determination or evaluation relating to the interactive communication that the sender or initiator of the interaction is able to answer. For example, the objective function is related to a survey question such as “How satisfied are you with the service agent's performance?” Alternatively, the objective function is related to a determination of what products and services the sender purchased. As yet another alternative, the objective function is related to a determination of products and services offered to the sender. As another alternative, the objective function is related to a determination of products and/or services that were cross-sold or up-sold to the sender. In step S403, a prescribed course of action is selected and implemented. The implementation of the prescribed course of action will be discussed in further detail with respect to FIGS. 4B, 5, 6 and 7.

By using the quantitative features and encoded qualitative features of the interactive communication as inputs to the regression model 401, a potential survey answer for the objective function “How satisfied are you with the agent's performance” is predicted. That is, the regression result obtained by inputting the quantitative features and encoded qualitative features of the interactive communication to the regression model 401 is a prediction of the potential survey answer. The potential survey answer or score predicts the sender's response to the survey question or objective function prior to or in place of obtaining an actual survey answer from the sender, given the sender's current interaction with the service agent as a predictor.

In FIG. 4B, a process flow diagram for implementing a first prescribed course of action, recommending products and services, is shown. The process begins with step S404 in which a prescribed course of action is determined based on the selected objective function and the potential survey answer predicted for the selected objective function in step S402. In this case, the prescribed course of action includes recommending products and/or services to the sender. In the exemplary embodiment, a recommendation database 405 storing information relating to products and services is provided as an input to step S404.

In step S406, it is determined whether an automated system implements the prescribed course of action determined in step S404 or whether a service agent (i.e., the recipient) acts in accordance with the prescribed course of action. The process proceeds to step S408 when it is determined that the system is to implement the prescribed course of action, that is, providing recommendations as to products and/or services. The process proceeds to step S410 when it is determined that the service agent is to implement the prescribed course of action. It should be noted that the process described in FIGS. 4A and 4B are initiated and may be repeated any number of times throughout the duration of the interactive communication. That is, as the interactive communication progresses, the predicted score for the selected objective function may be updated. Alternatively, predicted scores for different objective functions may be obtained. Accordingly, recommendations for different products and/or services are provided as the current, interactive communication, between the sender and the recipient, progresses.

As described above, the first prescribed course of action includes recommending a product, service or set of products and services, based on the score determined in step S402 of FIG. 4A. In one embodiment, survey answers are correlated and stored with information relating to products and/or services that were sold, up-sold or cross-sold during an interactive communication, in the recommendation database 405. In such case, a predicted score is used to obtain recommendations for products and services from the recommendation database 405. In another embodiment, features generated for the interactive communication are correlated with information relating to products and/or services that were sold, up-sold or cross-sold during an interactive communication, in the recommendation database 405. In such case, the features and/or the predicted score are used to obtain recommendations for products and/or services.

In one embodiment, the system provides recommendations for products and services to the service agent, or directly to the sender. In another embodiment, the system overrides services and products recommended by a service agent. In yet another embodiment, the recommendation database of offers, problems and thresholds is provided as an input to the regression model.

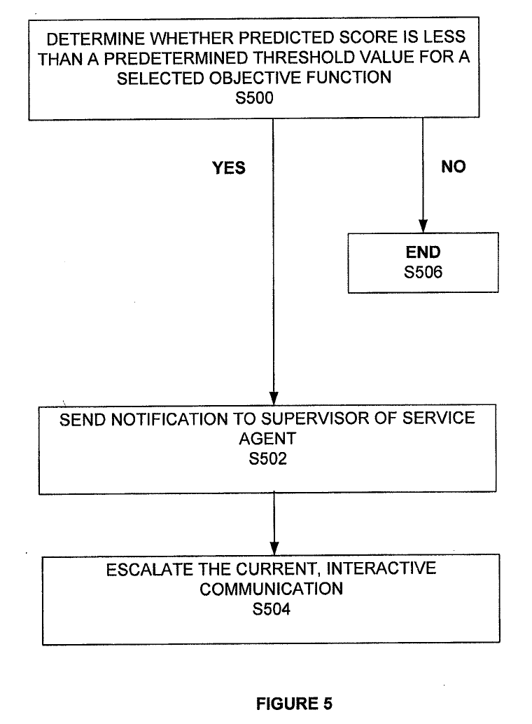

In FIG. 5, a process flow diagram for implementing a second prescribed course of action, automatic call escalation, is shown. Depending on the objective function for which a score is predicted in step S402, the process shown in FIG. 5 follows. For example, a relevant objective function with respect to FIG. 5 includes, how satisfied an initiator or sender is with the interactive communication. Another relevant objective function is, for example, the degree of certainty the sender has with respect to resolving an inquiry. Yet another relevant objective function is, for example, the sender's current emotional state. In step S500, it is determined whether the predicted score is less than a predetermined threshold value for a selected objective function. For example, if the predicted score determined with respect to the selected objective function indicates that a customer is sufficiently unsatisfied with the current interaction, the process proceeds to step S502 in which a notification is sent to a supervisor of the service agent. In step S504, the communication is escalated by the supervisor to another agent or to the supervisor that is better equipped to handle the current interaction via soft handoff. In another embodiment, the current communication is escalated via a hard handoff. That is, the system automatically escalates the communication to another agent or the supervisor without requiring intervention on the part of the supervisor.

It is noted that the process shown in FIG. 5 is repeated, in one embodiment, throughout the duration of the interactive communication. Accordingly, an interactive communication for which the threshold value had not been initially exceeded in step S500 may later be exceeded and escalated at the appropriate time. In another embodiment, if the predetermined threshold is not exceeded and the process does not repeat, the process ends in step S506.

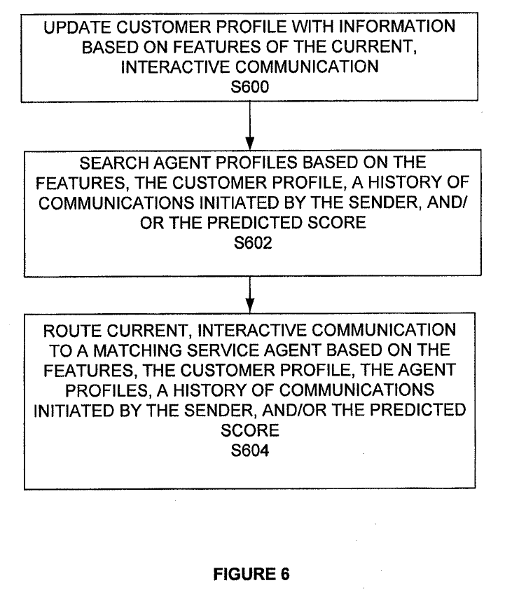

In FIG. 6, a process flow diagram for implementing a third prescribed course of action, re-routing communication, is shown. In step S600, features of the current, interactive communication are stored in a customer profile for the sender. In step S602, agent profiles are searched to find a matching service agent based on any one or combination of information from a customer profile for the sender, features obtained from the current, interactive communication, a history of communications initiated by the sender and the predicted score. For example, if features obtained from the interactive communication indicate that the sender has an accent, in step S602, agent profiles are searched for a matching service agent having a similar accent. Alternatively, if the customer profile indicates that the customer is a very difficult customer and has called many times, in step S602, agent profiles are searched for a matching service agent with sufficient experience to handle the current interactive communication. In one embodiment, a predicted score predicted for the selected objective function in step S402 of FIG. 4A is additionally or alternatively used to find a matching service agent. In such case, a relevant objective function is one that answers the survey question “What do you think is the probability your problem will be resolved?” If the predicted score indicates a low probability that the problem will be resolved, then the agent profiles are searched for a matching service agent that has, for example, expert experience with the problem the sender wishes to resolve.

In step S604, the current, interactive communication is routed to the matching service agent based on any one or combination of information from the customer profile for the sender, features obtained from the current, interactive communication, a history of communications initiated by the sender, the agent profiles and the predicted score.

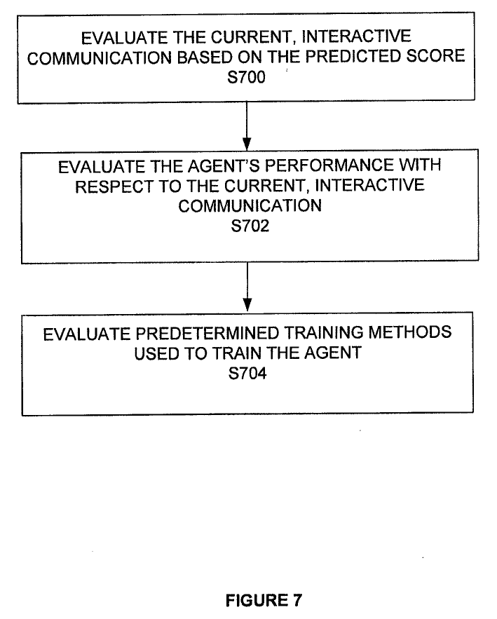

In FIG. 7, a process flow diagram for implementing a fourth prescribed course of action, evaluating a communication transcript and agent performance, is shown. In step S700, an evaluation is produced based on the predicted score for the selected objective function. In step S702, the agent's performance with respect to the current interaction is evaluated. For example, if a predicted score for the selected objective function indicates that the sender is dissatisfied with the current, interactive communication, the agent may be evaluated as performing poorly. In step S704, the predetermined training methods for training the service agent handling the current interactive communication are reviewed. Accordingly, the next time the sender communicates with the communications center, or the next time any sender communicates with the communications center, the evaluated service agent will follow a different script for communicating with future senders.

Accordingly, the present invention enables predicting communication outcome based on a regression model.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, a customer calls a call center for an entity to solve a problem with a malfunctioning cable modem. The service agent responsible for answering the customer's call follows a predetermined script for attempting to resolve the customer's issue. If the script does not resolve the customer's problem, the customer may become frustrated. Quantitative features such as curse words used during the call (e.g., 2 curse words), call duration (e.g., 4 minutes) and word length of sentences (e.g., average of 18 words per sentence) are obtained from a transcript of the call. Qualitative features such as the emotional state of the customer as well as the emphasis, contrast, and focus of call are obtained from the call transcript. The qualitative features are encoded. In the current example, the customer is determined to be frustrated, which is encoded as the number “8” on a scale of 1-10. For example, a regression equation is

S=2w³−x²+0.3y−0.2z,

where S=the predicted survey score for the selected objective function,

w=a quantitative feature of the number of curse words used during the call,

x=a quantitative feature of call duration (in minutes),

y=a quantitative feature of word length of words (in sentences), and

z=an encoded value for a qualitative feature of the emotional state of the customer (on a scale of 1-10).

Each of the quantitative features and the encoded values for the qualitative features are applied to a regression model as values for the independent variables. In this case, the regression model predicts a survey score for the objective function or survey question, “How satisfied are you today with your interaction with the service agent”. Based on the regression model and the exemplary inputs, the predicted survey score for the exemplary survey question is 3.8.

Based on the predicted score, any number of prescribed courses of action are selected. In this case, the predicted survey score is compared to a predetermined threshold for satisfaction with the service agent's performance (e.g., a score of 5 on a scale of 1-10). Because the predicted score is less than the predetermined threshold, the communication is escalated to a supervisor or more senior agent. In one embodiment, the call is automatically escalated. In another embodiment, the service agent is given an option to escalate the call. In yet another embodiment, the service agent's supervisor is notified and is given the option to escalate the call for the service agent.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for Internet and other packed switched network transmission, telecommunication networks and data networks represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for predicting a score related to a communication sent by a sender over a communications network to a first agent servicing the communication, comprising:
obtaining a regression result for an objective function by encoding features extracted from the communication and applying the encoded features to a regression model for the objective function; and
outputting the regression result to a network component in the communications network,
wherein the regression model is determined prior to or concurrently with receiving the communication from the sender.

2. The method according to claim 1,
wherein the regression model for the objective function is determined based on communication transcripts and performance data.

3. The method according to claim 1,
wherein the features comprise communication metadata, acoustic, lexical, syntactic, prosodic, semantic and phonetic features of the communication.

4. The method according to clam 1,
wherein the regression result is obtained in real-time as the communication is being sent by the sender.

5. The method according to claim 1, further comprising:
evaluating performance for the agent servicing the communication, based on the regression result, by reviewing a stored version of the communication.

6. The method according to claim 5,
wherein predetermined methods for training the agent are revised based on at least one of the regression result and evaluating performance for the agent servicing the communication.

7. The method according to claim 1,
wherein an alert is generated when the regression result is less than a predetermined threshold.

8. The method according to claim 1, further comprising:
escalating the communication to a second agent in real-time when the regression result is less than a predetermined threshold.

9. The method according to claim 1,
wherein the communication is routed to a second agent based on at least one of: features of the communication, the regression result, a plurality of agent profiles, a profile for the sender and a history of communications initiated by the sender and a plurality of agent profiles.

10. The method according to claim 2,
wherein the performance data comprises numeric, encoded and binary answers to a plurality of survey questions.

11. A system for predicting a score related to a communication sent by a sender over a communications network to a first agent servicing the communication, comprising:
an obtainer, implemented on at least one processor, that obtains a regression result for an objective function by encoding features extracted from the communication and applying the encoded features to a regression model for the objective function; and
an outputter, implemented on at least one processor, that outputs the regression result to a network component in the communications network,
wherein the regression model is determined prior to or concurrently with receiving the communication from the sender.

12. The system according to claim 11,
wherein the communication comprises text messages, short messaging system messages, electronic mail, facsimile, postal mail, Internet web posts, chat client messaging, audio files and video files.

13. The system according to claim 11,
wherein the objective function represents a survey question, and
wherein the regression result predicts a survey answer to the survey question.

14. The system according claim 11,
wherein the first agent is a human agent or a computer-based agent.

15. The system according to claim 11,
wherein the first agent comprises an interactive voice response system.

16. The system according to claim 11, further comprising:
a database storing recommendations for products and services.

17. The system according to claim 16,
wherein the recommendations for products and services are based on at least one of the regression result and correlating features extracted from pre-stored communication transcripts with products and services offered to or purchased by senders of the pre-stored communication transcripts.

18. The system according to claim 16,
wherein the recommendations for products and services are automatically provided to the sender.

19. The system according to claim 16,
wherein the first agent provides the recommendations to the sender.

20. A computer readable medium, storing a computer program recorded on the computer readable medium, that predicts a score related to a communication sent by a sender over a communications network to a first agent servicing the communication, comprising:
an obtaining code segment, recorded on the computer readable medium, that obtains a regression result for an objective function by encoding features extracted from the communication and applies the encoded features to a regression model for the objective function; and
an outputting code segment, recorded on the computer readable medium, that outputs the regression result to a network component in the communications network,
wherein the regression model is determined prior to or concurrently with receiving the communication from the sender.
